(19) United States
(12) Patent Application Publication
(10) Pub. No.: US 2004/0028333 A1
(43) Pub. Date: Feb. 12, 2004

(54) Tunable optical filter

(76) Inventor: Martin Lomas, Chilwell (GB)

Correspondence Address: Kirschstein Ottinger, Israel & Schiffmiller, 489 Fifth Avenue, New York, NY, 10017-6105, US

(21) Appl. No.: 10/344,539

(22) PCT Filed: Aug. 8, 2001
(86) PCT No.: PCT/GB01/03600

(30) Foreign Application Priority Data
Aug. 18, 2000 (GB) 0020307.5

(51) Int. Cl. G02B 6/26

(52) U.S. Cl. 385/39; 385/25

(57) ABSTRACT

A tunable optical filter comprises an optical filter plate for filtering an optical radiation beam, the filter plate exhibiting a spatially non-uniform optical filtration characteristic. Optical beam forming components are provided for receiving optical input radiation at the filter and forming the input radiation into the radiation beam, and for receiving the beam after its optical interaction with the filter plate for forming output radiation for output from the filter. Additionally, actuation components are provided for controllably moving the filter plate relative to the radiation beam for selecting preferred filtration characteristics of the filter plate. The actuation components include a threaded drive shaft whose thread has leading and trailing thread faces; and threaded nut regions resiliently engaging the leading and trailing thread faces of the drive shaft for reducing backlash, the threaded nut regions being in communication with the filter plate for moving the filter plate relative to the radiation beam in response to rotation of the drive shaft member relative to the threaded nut regions.

The present invention concerns a tunable optical filter for use in optical communication systems.

Conventional optical communication systems comprise a plurality of spatially distributed nodes interconnected through optical fibre waveguides. Information bearing optical radiation is conveyed through the waveguides for communicating information between the nodes. Optical radiation in the context of the present invention is defined as electromagnetic radiation having a wavelength substantially in a range of 150 nm to 5 μm.

The information is often modulated onto the optical radiation in a manner of wavelength division multiplexing (WDM), namely the information is subdivided into a number of channels, each channel being modulated onto a corresponding range of optical radiation wavelenghths. For example, where 1.5 μm wavelength optical radiation is employed, the wavelength ranges associated with the channels can be sequentially spaced at 0.8 nm intervals. Optical radiation filters are conventionally employed in the systems for isolating radiation associated with specific channels.

When the systems are non-reconfigurable, optical filters therein are set at manufacture to radiation wavelengths of specific channels. However, it is increasingly a requirement that communication systems should be reconfigurable which necessitates such systems including optical filters tunable over a range of at least several channels.

Although mechanically tunable optical radiation filters are known, for example in laboratory or astronomical spectrometers, such filters are conventionally regarded as being too costly, unreliable, bulky and slow for use in modern optical communication systems where frequent tuning adjustment is required to select between channels, for example when reconfiguring nodes. Moreover, it is known that precision mechanisms suffer problems of wear when adjusted frequently, such wear giving rise to mechanical backlash which can limit adjustment accuracy. As a result, thermally-tuned optical radiation filters and electronically-switchable optical filters are conventionally employed in optical communication systems.

In a U.S. Pat. No. 5,459,799, there is described a tunable optical filter for use in WDM multiplexing communication systems. The filter comprises a series arrangement of reflection gratings; each grating is operable to block radiation over a wavelength range of a corresponding channel associated with the grating. Moreover, the gratings are fabricated to block mutually different channels so that the filter is normally operable to block all channels comprising WDM radiation input to the arrangement. An electrode or a heating element is provided for each reflection grating for detuning it; control signals applied to the electrodes or elements can shift the wavelength ranges of their associated gratings to be non-coincident with one or more desired channels to be selectively transmitted through the series arrangement The arrangement suffers the disadvantage that it is not continuously tunable; its tuning can only be switched in discrete wavelength steps corresponding to radiation blocking bandwidths of its gratings. Such discrete steps are a limitation if communication systems including such filters are to be upgraded in the future where finer wavelength steps are required, for example where channel wavelength spacings are to be reduced from 0.8 nm to 0.3 nm. Moreover, in order to obtain a fine tuning resolution, the series arrangement needs to incorporate many reflection gratings which makes the arrangement complex and costly to manufacture.

The inventor has appreciated that it is desirable for optical communication systems to incorporate filters which are continuously tunable, or at least tunable in sufficiently fine wavelength steps to cope with future upgrades of the systems. Moreover, in contrast to conventional practice in optical communication system design, the inventor has appreciated that mechanical optical filters can be adapted to provide acceptable performance in future optical communication systems, especially with regard to reducing backlash to an acceptable degree.

According to a first aspect of the present invention, there is therefore provided a tunable optical filter comprising:optical filtering means for filtering an optical radiation beam received thereat, the filtering means exhibiting a spatially non-uniform optical filtration characteristic; optical beam forming means for receiving optical input radiation at the filter and forming the input radiation into the radiation beam, and for receiving the beam after its optical interaction with the filtering means for forming output radiation for output from the filter, characterised in that the filter further comprises: actuating means for controllably moving the filtering means relative to the radiation beam for selecting preferred filtration characteristics of the filtering means, the actuating means including: a threaded drive member whose thread has leading and trailing thread faces; and a complementary threaded receiving member resiliently engaging the leading and trailing thread faces of the drive member for reducing backlash, the receiving member being in communication with the filtering means for moving the filtering means relative to the radiation beam in response to rotation of the drive member relative to the receiving member.

The invention provides the advantage that backlash in the optical filter can be reduced to a sufficiently low level to render the filter usable in reconfigurable optical communication systems.

Backlash is defined as an adjustment inaccuracy dependent upon direction of mechanism movement which is not subject to a resilient biasing force capable of compensating for the adjustment inaccuracy.

Conveniently in order to reduce backlash, the receiving member includes mutually resiliently-biased first and second components for engaging onto the leading and trailing thread faces of the drive member. Applying a resilient biasing force to both leading and trailing edges ensures that backlash within the filter is absorbed

The drive member preferably comprises a rotatably mounted threaded shaft, the first and second components comprising first and second threaded regions for engaging onto the shaft, the first region being in mechanical communication with the filtering means and the second region being constrained to be in substantially constant angular orientation with respect to the first region. Such an arrangement provides an enhanced degree of abutment to the trailing and leading thread edges, especially when the filter's mechanism suffers wear in use.

It is desirable that the filter should be manufacturable using readily available parts to reduce cost. Thus, beneficially, the first and second regions can be mutually resiliently biased by an elastic member located therebetween. Conveniently, the first and second regions are mutually resiliently biased by a spring therebetween, for example a helical spring. The elastic member can alternatively, for example, comprise an elastic polymeric material.

In order to rotationally constrain the second region relative to the first region, the second region is advantageously a threaded nut including one or more projections for slidably engaging onto at least one surface in mechanical communication with the first region.

In order to greatly simplifying filter construction in comparison to employing the aforementioned first and second threaded regions, the threaded receiving member is preferably a compliant member including an undersized hole for receiving the threaded drive member. Such construction considerably reduces the number of parts required although using a compliant unitary receiving member is likely to suffer from wear more rapidly than using the aforesaid resiliently biased first and second threaded members. Conveniently, the compliant member is fabricated from an elastic polymeric material.

When the threaded receiving member is a unitary component, it is advantageously fabricated from one or more of: nylon 6-6, polytetrafluoroethylene (PTFE), polyethylene glycol, polyethylene oxide and polyethylene. Such materials exhibit necessary compliance for absorbing backlash within the filter.

Conveniently, the actuating means includes a motor for controllably rotating the threaded drive member, and an electronic control assembly for receiving control signals at the filter and driving the motor in response to the signals. The motor can be one or more of a stepper motor, a d.c. motor and a linear motor. Stepper motors are essentially digital devices which are suitable for interfacing to other digital circuits within optical communication systems.

In order for the communication systems to monitor tuning status of the filter, the filter advantageously includes transducing means for measuring spatial position of the filtering means relative to the radiation beam. The transducing means enables a communication system connected to the filter to establish a positional feedback loop encompassing the transducing means and the stepper motor for servoing the filter to preferred filter settings. In order to reduce manufacturing cost, the transducing means conveniently includes a potentiometer whose output potential alters in response to movement of the filtering means relative to the radiation beam. However, potentiometers are well known to suffer wear after long periods of use which can render them noisy and unreliable. In order to address such wear, the transducing means preferably includes an optical encoder mechanically in communication with the filtering means for measuring spatial position of the filtering means relative to the radiation beam.

Conveniently, the filtering means is a multilayer optical etilon structure whose layer thickness or composition spatially varies to provide the non-uniform optical filtration characteristic. Etalons are capable of providing specific relatively narrow filtration characteristics necessary for isolating radiation corresponding to specific channels in communication systems.

Alternatively, the filtering means is preferably a diffraction grating structure whose grating period spatially varies to provide the non-uniform optical filtration characteristic.

In operation, it is desirable that the filtering means should be held rigidly relative to the radiation beam so that the filter is relatively immune to vibration and other environmental influences. Thus, the filtering means is beneficially mounted on a stage constrained by mechanical guides to move substantially in a linear trajectory relative to the radiation beam in response to being mechanically driven by the actuating means.

Embodiments of the invention will now be described, by way of example only, with reference to the following diagrams in which:

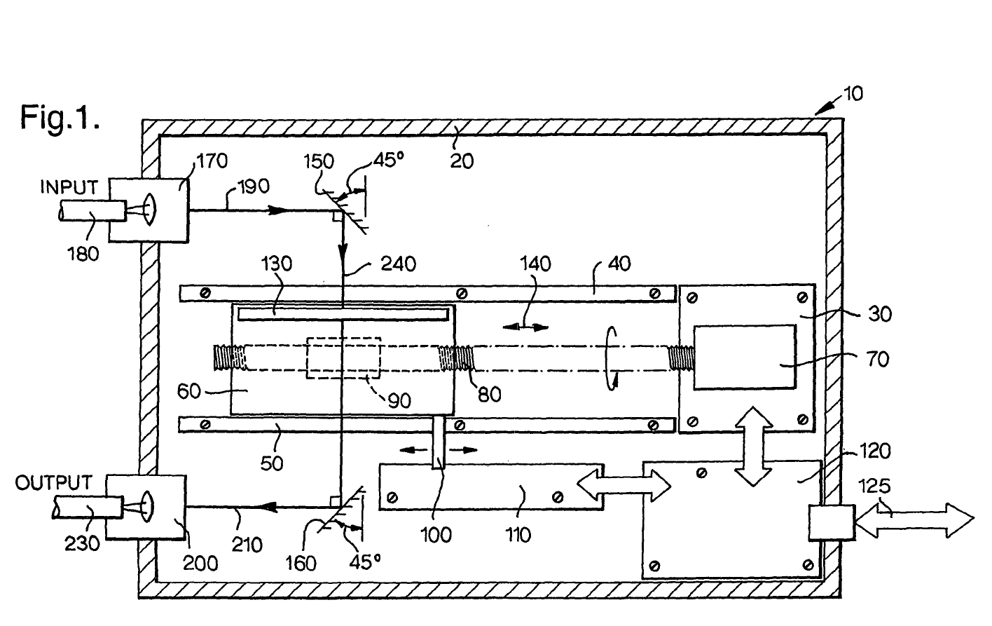

FIG. 1 is a plan-view schematic diagram of a mechanical tunable optical radiation filter according to an embodiment of the invention;

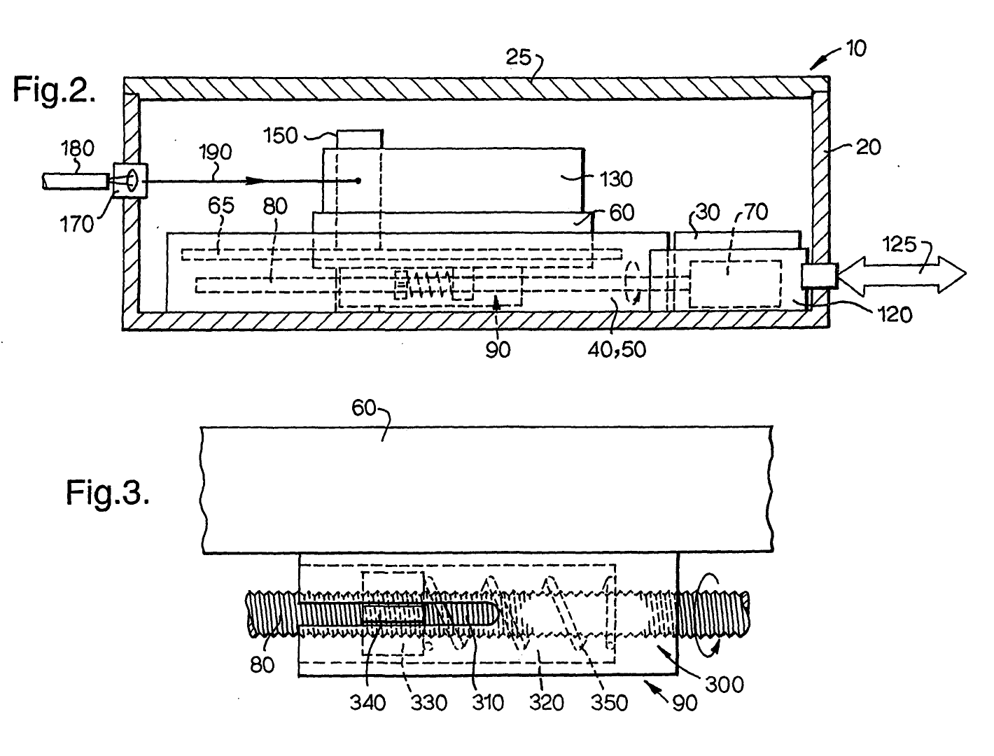

FIG. 2 is a side-view schematic diagram of the filter illustrated in FIG. 1;

FIG. 3 is a side-view illustration of a threaded nut assembly of the filter shown in FIGS. 1 and 2;

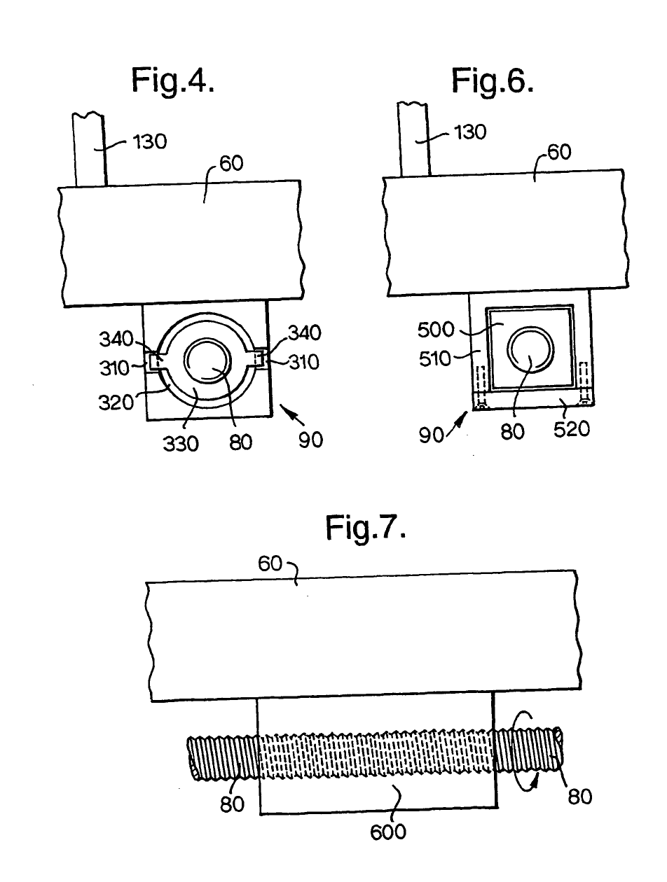

FIG. 4 is an end-view illustration of the nut assembly shown in FIG. 3;

FIG. 5 is an expanded view of the nut assembly illustrated in FIGS. 3 and 4;

FIG. 6 is an illustration of an alternative form of nut assembly for use in the filter shown in FIGS. 1 and 2; and

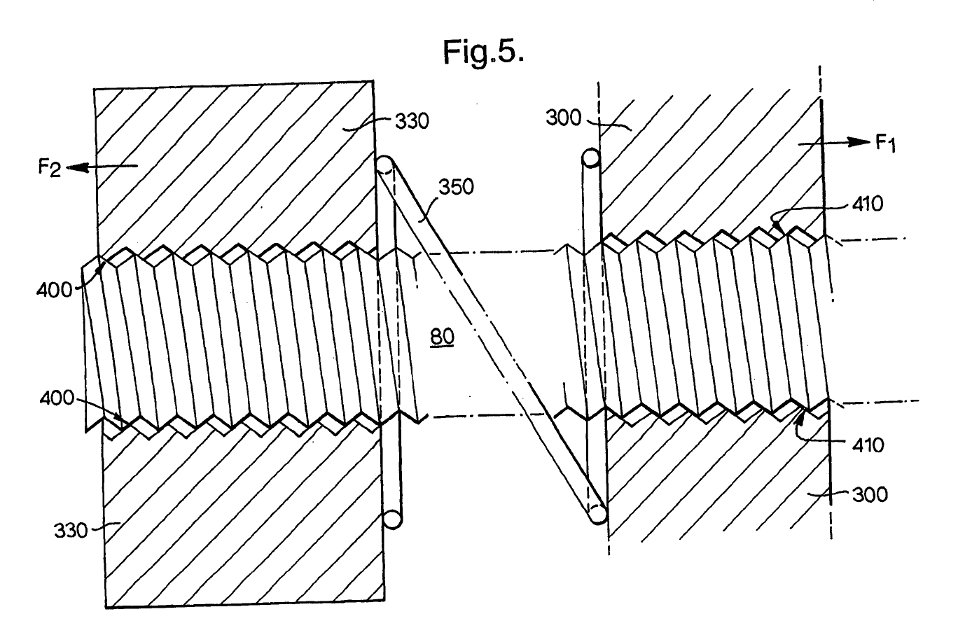

FIG. 7 is an illustration of a further alternative form of nut assembly for use in the filter shown in FIGS. 1 and 2.

Referring now to FIGS. 1 and 2, there is shown a mechanical tunable optical filter indicated by 10. The filter 10 comprises an exterior casing 20 with an associated lid 25, a mounting block 30 attached by screws to the casing 20, mutually parallel-disposed mechanical guides 40, 50 between which a movable stage indicated by 60 is mounted in precision machined slots 65 formed into the guides 40, 50. The block 30 includes a stepper motor 70 whose rotatable screw-threaded shaft 80 is disposed in a direction parallel to elongate axes of the guides 40, 50 and midway therebetween. The stage 60 comprises a threaded nut assembly 90 attached to the stage 60 and engaging onto the screw-thread of the shaft 80. The stage 60 further comprises a projection 100 linked to a lateral position transducer 110 mounted onto the casing 20 in fixed position and orientation relative to the block 30 and the guides 40, 50. The filter 10 additionally comprises an electronic control circuit 120 which is connectable through an interface bus 125 to other parts (not shown) of an optical communication system into which the filter 10 is incorporated. The circuit 120 is coupled through a drive bus to the motor 70 and through a transducer bus to the position transducer 110.

The stage 60 also includes an optical filter plate 130 onto which, during its manufacture, has been deposited a plurality of optical layers which function as an optical etilon. The layers are arranged to have a thickness which is spatial tapered along the plate 130 so that the plate 130 exhibits a transmission response whose-transmission wavelength spatially varies along the plate 130. Alternatively, the layers can be fabricated to have a spatially varying composition for providing a transmission response which varies spatially along the plate 130. The plate 130 is mounted onto the stage 60 within the filter 10 so that the plate's elongate axis is parallel to a direction of travel of the stage 60 within the casing 20, the direction being indicated by an arrow 140. Methods of fabricating the plate 130 are known in the art.

The plate 130 can alternatively include a diffraction grating structure rather than the plurality of optical layers, the grating structure having a grating period which is spatially non-uniform therealong.

The filter 10 includes first and second mirrors 150, 160 respectively mounted onto the casing 20 in fixed spatial relationship to the guides 40, 50 and the block 30. The mirrors 150, 160 are orientated such that their reflecting surfaces are at an angle of 45° relative to the direction indicated by the arrow 140, namely at substantially 45° to the elongate axes of the guides 40, 50. The filter 10 additional includes an input optical interface 170 for receiving radiation from a first optical fibre waveguide 180 and for outputting in use a corresponding first free-space radiation beam 190 within the casing 20, and an output optical interface 200 for receiving in use a second free-space radiation beam 210 and coupling it as radiation into a second optical fibre waveguide 230. 10

It will be appreciated that the stepper motor 70 can be replaced with other types of motor in alternative versions of the filter 10, for example the stepper motor 70 can be replaced by one or more of a d.c. motor, a linear motor or a solenoid motor actuating the screw-threaded shaft 80. 15

Operation of the filter 10 will now be described with reference to FIGS. 1 and 2. Input radiation comprising radiation components of several channels is guided along the fibre waveguide 180 to the optical interface 170. The interface 170 forms the input radiation into the first radiation beam 190 which propagates to the reflecting surface of the first mirror 50. The first mirror 150 reflects radiation received thereat to form a third radiation beam 240 which propagates towards the plate 130; the third beam 240 is received perpendicularly at a region of the plate 130. A radiation component in the third beam 240 corresponding to a range of transmission wavelengths transmitted by the region of the plate 130 is transmitted through the plate 130 and propagates onwards towards the second mirror 160 at which it is received. The second mirror 160 reflects radiation received thereat to form the second beam 210 which passes to the second optical interface 200 whereat it is collected and focussed into the second fibre waveguide 230 along which it further propagates.

By moving the stage 60 laterally with respect to the mirrors 40, 50, the third beam 240 is received onto preferentially selected regions of the plate 130, thereby tuning the filter 10. The position transducer 10 senses position of the stage 60 with respect to the mirrors 150, 160 and hence with respect to the third beam 240, thereby providing an indication of a wavelength to which the filter 10 is tuned. The stage 60 is moved relative to the third beam 240 by rotating the shaft 80 using the stepper motor 70. The motor 70 is powered from the control circuit 120 which determines how many steps the shaft 80 is to be turned in response to control instructions received at the circuit 120 via the interface bus 125 from the communication system (not shown). Moreover, the control circuit 120 is also operable to receive a position sensing signal from the transducer 110 and to process it into a suitable digital format for outputting to the system via the interface bus 125. By monitoring the processed position sensing signal, the system can tune the filter 10 to a preferred wavelength.

The transducer 110 is conveniently a potentiometer for lower cost applications where high positional accuracy of the stage 60 is not so critical. When greater position sensing accuracy is required, the transducer 110 can be an optical transducer exploiting, for example, Moiré fringe counting techniques, or an optical encoder.

The nut assembly 90 has been developed by the inventor to be substantially devoid of backlash. Such backlash reduction imparts enhanced adjustment accuracy and precision of optical tuning to the filter 10. Moreover, the nut assembly 90 is also capable of accommodating wear of the thread of the shaft 80, thereby increasing the reliability of the filter 10 to an extent rendering it acceptable for long-term use over several years in future optical communication systems in preference to aforementioned electronically tunable filters.

The nut assembly 90 will now be further described with reference to FIGS. 3 and 4. The nut assembly 90 comprises an assembly casing attached to the stage 60, the casing including a first nut region 300 comprising a threaded hole for engaging onto the threaded shaft 80. The assembly casing further comprises two slots 310 on both lateral sides thereof and also includes an elongate void region 320 of circular form as illustrated in FIG. 4 between the slots 310. The first nut region 300 is formed at one end of the void region 320. The casing can, for example, be fabricated from bronze, aluminium or stainless steel into which the void region 320 and the slots 310 have been milled, and the hole and associated thread of the first nut region 310 have been formed.

The assembly 90 additionally comprises a second threaded nut 330 including a central threaded hole therein for engaging onto the shaft 80. The threaded nut 330 includes two projections 340 which are in sliding engagement with the slots 310. A helical compression spring 350 is incorporated in the void region 320 between the first nut region 300 and the second threaded nut 330.

In operation, the spring 350 is maintained in compression thereby applying a substantially constant biasing force separating the first and second nuts 300, 330. As a consequence of both nuts 300, 330 engaging onto the threaded shaft 80 and maintaining a constant mutual relative angular orientation and separation, the biasing force remains substantially constant as the shaft 80 is turned relative to the nuts 300, 330 and the stage 60 for moving the stage 60 within the exterior casing 20.

It will be appreciated that the spring 350 can be replaced with other types of elastic component in alternative versions of the filter 10, for example the spring 350 can be replaced an elastic member providing a repulsive or attracting force between the nuts 300, 330 for absorbing backlash.

The projections 340 are preferably a precise fit in the slots 310, for example with not more than 25 μm clearance. Such a precise fit ensures that vibrations caused by the projections 340 contacting onto side edges of the slots 310 when the motor 70 reverses rotation direction of the shaft 80 does not cause disturbance of the plate 130 and hence degrade optical performance of the filter 10.

The biasing force developed by the spring 350 mutually repelling the nuts 300, 330 is effective at reducing backlash in the filter 10. Moreover, the force also compensates for wear occurring to the thread of the shaft 80 and also to threads of the nuts 300, 330 engaging onto the shaft 80.

If required, the helical spring 350 can be replaced with another type of compliant component capable of applying a force for mutually separating the nuts 300, 330; for example, an elastic compressible polymer sleeve can be used instead of the spring 350.

The nut assembly 90 provides the benefit of providing a substantially constant force for absorbing backlash. Backlash can alternatively be reduced by resiliently biasing the stage 60 relative to the exterior casing 20 instead of relying on the nut assembly 90, for example by including a compression spring between the stage 60 and the casing 20; such resilient biasing of the stage 60 with respect to the casing 20 has the disadvantage that a force developed between the casing 20 and the stage 60 varies as the stage 60 is moved relative to the casing 20, thereby resulting in more uneven wear of the thread of the shaft 80 compared to when the nut assembly 90 is employed.

Operation of the nut assembly 90 will now be described in further detail with reference to FIG. 5. The spring 350 develops a repulsion force F₁ which engages the first nut 300 onto trailing thread faces of the thread of the shaft 80 as indicated by 410. Moreover, the spring 350 also develops a corresponding repulsion force F₂ which engages the second nut 330 onto leading thread faces of the thread of the shaft 80 as indicated by 400. By resiliently engaging both leading and trailing edges, backlash is greatly reduced in the filter 10.

The assembly 90 can be modified to simplify its manufacture. An alternative assembly 90 is illustrated in FIG. 6 where a second nut 500 for engaging onto the shaft 80 is of rectilinear exterior form. An alternative version of a casing 510 for the assembly 90 includes a rectangular-form void for slidably accommodating the second nut 500. The void can be generated by a milling operation. Moreover, a removable retaining plate 520 can be screwed into the casing 510 when the second nut 500 has been installed to restrain lateral movement of the second nut 500 in operation.

The assembly 90 can be further simplified as illustrated in FIG. 7. The nut assembly can be implemented as a compliant polymer block 600 attached to the stage 60 and including a threaded hole therethrough for engaging onto the thread of the shaft 80. On account of the block 600 being compliant, it is effective at resiliently engaging both leading and trailing thread faces of the thread of the shaft 80. Conceptually, the aforementioned first and second nuts 300, 330 are effectively merged in the form of the block 600 and the material of the blocks provides the resilient biasing force for engaging onto the thread faces. In manufacture, it is important to ensure that the hole in the block 600 for accommodating the shaft 80 is slightly undersized to obtain resilient engagement of the shaft 80 and the block 600 in operation; if the hole is oversized, backlash will become manifest.

The block 600 is preferably fabricated from a resilient polymer such as one or more of nylon 6-6, polytetrafluoroethylene (PTFE), polyethylene glycol, polyethylene oxide and polyethylene.

Alternatively, the block 600 can be fabricated from a metal or metal alloy, for example stainless steel, bronze or aluminium, and the thread of the shaft 80 conformally coated in a layer of compliant polymer for resiliently engaging onto both leading and trailing faces of a corresponding thread formed in a hole in the block 600 for accommodating the shaft 80. However, when such an alternative arrangement is employed, manufacturing tolerances need to be much more precisely controlled in comparison to tolerances in the nut assembly 90 illustrated in FIGS. 1 to 4.

It will be appreciated that modifications can be made by one skilled in the art to the filter 10 without departing from the scope of the invention. For example, the thread of the shaft 80 and complementary threads on the first and second nuts 300, 330 can be of sinusoidal cross-section form. Alternatively, the threads can be of rectangular cross-section form with a layer of compliant polymer such as PTFE on and leading and trailing edges of such threads.

In the foregoing, it is to be appreciated that employing a nut assembly 90 comprising a single nut for engaging onto the shaft 80 together with a viscous filling agent such as petroleum grease, oil or lubricant powder for filling tolerance voids between the thread of the shaft 80 and that of the nut is not a satisfactory solution for reducing backlash in the filter 10; such a viscous filling agent is capable of redistributing itself when the filter 10 is in use, thereby resulting in non-reproducibility of position of the stage 60 within the casing 20 when the motor 70 is instructed to move the stage 60 to a preferred position, such non-reproducibility manifest as backlash.

In the foregoing, the shaft 60 is itself resiliently biased, for example by a circular leaf spring in the motor 70, so that the shaft 80 does not exhibit axial linear backlash with respect to the guides 40, 50 and the exterior casing 20.

Although the filter 10 is described in the foregoing as including the stage 60 on which is carried the optical filter plate 130, the filter plate 130 being linear actuated relative to the third beam 240, it will be appreciated that the filter 10 can be modified so that the stage 60 is implemented as a rotational member turned by rotation of the shaft 80 relative thereto. The thread of the shaft 80 can engage complementary structures on the rotational member capable of engaging onto leading and trailing edges of the thread.

In the foregoing, a resilient biasing force between the first nuts 300, 330 is provided by the helical spring 350 to ensuring resilient engagement of the nuts 300, 330 onto leading and trailing thread edges of the shaft 80. In an alternative embodiment of the filter 10, the spring 350 can be omitted and magnetic components employed instead to apply a force to the nuts 300, 330 to ensure resilient engagement onto the shaft 80. The magnetic components can be arranged to provide an attracting or repulsive force as appropriate. Moreover, the magnetic components can be based on one or more of permanent magnetic materials and electromagnets.

Electrostatic generation of a resilient force for resiliently engaging the nuts 300, 330 onto the shaft 80 is also possible.

1. A tunable optical filter (10) comprising: optical filtering means (130) for filtering an optical radiation beam (240) received thereat, the filtering means exhibiting a spatially non-uniform optical filtration characteristic; optical beam forming means (150, 160, 170, 200) for receiving optical input radiation (180) at the filter (10) and forming the input radiation into the radiation beam (240), and for receiving the beam after its optical interaction with the filtering means for forming output radiation (230) for output from the filter (10), characterised in that the filter further comprises: actuating means (40, 50, 60, 70, 80) for controllably moving the filtering means (130) relative to the radiation beam (240) for selecting preferred filtration characteristics of the filtering means (130), the actuating means including: a threaded drive member (80) whose thread has leading (400) and trailing (410) thread faces; and a complementary threaded receiving member (300, 330) resiliently engaging the leading (400) and trailing (410) thread faces of the drive member (80) for reducing backlash, the receiving member (300, 330) being in communication with the filtering means (130) for moving the filtering means (130) relative to the radiation beam (240) in response to rotation of the drive member (80) relative to the receiving member (300, 330).

2. A filter according to claim 1 wherein the receiving member. (300, 330) includes mutually resiliently-biased first (300) and second (330) components for engaging onto the leading (400) and trailing (410) thread faces of the drive member (80).

3. A filter according to claim 2 wherein the drive member (80) comprises a rotatably mounted threaded shaft, the first and second components (300, 330) comprising first and second threaded regions for engaging onto the shaft, the first region (300) being in mechanical communication with the filtering means (130) and the second region (330) being constrained to be in substantially constant angular orientation with respect to the first region.

4. A filter according to claim 3 wherein the first and second regions are mutually resiliently biased by one or more of a magnetic force and an electrostatic force.

5. A filter according to claim 3 wherein the first and second regions are mutually resiliently biased by an elastic member located therebetween.

6. A filter according to claim 5 wherein the first and second regions are mutually resiliently biased by a spring (350) therebetween.

7. A filter according to claim 3, 4, 5 or 6 wherein the second region is a threaded nut (330) including one or more projections (340) for slidably engaging onto at least one surface in mechanical communication with the first region.

8. A filter according to claim 1 wherein the threaded receiving member is a compliant member including an undersized hole for receiving the threaded drive member.

9. A filter according to claim 8 wherein the compliant member is fabricated from a polymeric elastic material.

10. A filter according to claim 9 wherein the polymeric elastic material comprises one or more of: nylon 6-6, polytetrafluoroethylene (PTFE), polyethylene glycol, polyethylene oxide and polyethylene.

11. A filter according to any preceding claim wherein the actuating means includes a motor (70) for controllably rotating the threaded drive member (80), and an electronic control assembly (120) for receiving control signals at the filter and driving the motor in response to the signals.

12. A filter according to claim 11 wherein the motor (70) is one or more of a stepper motor, a d.c. motor and a linear motor.

13. A filter according to any preceding claim including transducing means (110) for measuring spatial position of the filtering means (130) relative to the radiation beam (240).

14. A filter according to claim 13 wherein the transducing means (110) includes a potentiometer whose output potential alters in response to movement of the filtering means relative to the radiation beam.

15. A filter according to claim 13 wherein the transducing means includes an optical encoder mechanically in communication with the filtering means for measuring spatial position of the filtering means relative to the radiation beam.

16. A filter according to any preceding claim wherein the filtering means (130) is a multilayer optical etilon structure whose layer thickness or composition spatially varies to provide the non-uniform optical filtration characteristic.

17. A filter according to any preceding claim wherein the filtering means is a diffraction grating structure whose grating period spatially varies to provide the non-uniform optical filtration characteristic.

18. A filter according to any preceding claim wherein the filtering means is mounted on a stage (60) constrained by mechanical guides (40, 50) to move substantially in a linear trajectory relative to the radiation beam in response to being mechanically driven by the actuating means.

19. A filter according to any one of claims 1 to 17 wherein the optical filtering means (130) is mounted on a rotational member turnable in response to rotation of the threaded drive member.
